(19) United States
(12) Patent Application Publication
(10) Pub. No.: US 2012/0097815 A1
(43) Pub. Date: Apr. 26, 2012

(54) CLIP

(75) Inventors: Takanori Morita, Kanagawa (JP); Takashi Sugimoto, Kuala Lumpur (MY)

(73) Assignee: NIFCO INC., Yokohama-shi (JP)

(21) Appl. No.: 13/138,900

(22) PCT Filed: Mar. 31, 2010
(86) PCT No.: PCT/JP2010/055927

§ 371 Date: Dec. 27, 2011

(30) Foreign Application Priority Data
Apr. 24, 2009 (JP) 2009-106086

(51) Int. Cl. F16M 13/02

(52) U.S. Cl. 248/224.8

(57) ABSTRACT

A clip includes a fixing portion and a holding portion. The fixing portion includes an elastic piece elastically abutting against a front surface of a panel; a support pillar extending toward an attachment hole from the elastic piece; a clamping piece protruding from an end portion of the support pillar, including an external form so as to be capable of passing through the attachment hole, and abutting against a back surface of the panel when the clamping piece is slid in one direction after passing through the attachment hole; and an operating piece provided in one portion of the elastic piece. The clamping piece is configured so that a distance from a front end portion at a front in a sliding direction to an edge portion of the attachment hole positioned in front of the sliding direction is longer than a sliding amount.

### TECHNICAL FIELD

The present invention relates to a clip for holding a component in an attachment hole of a panel. After a fixing portion of the clip is inserted into the attachment hole, the fixing portion is fixed by being slid. At this time, interference between the fixing portion and the attachment hole can be prevented, and the clip can be smoothly and easily attached and removed.

### BACKGROUND ART

Conventionally, there is well known a clip in which a clamping piece positioned on a back surface side of the panel contacts a back surface of the panel at three portions triangularly disposed, i.e. one-end-side edge portion at a sliding direction side of the attachment hole and both-side edge portions which are adjacent to the one-end-side edge portion, and at the contacted three portions, the edge portions of the three portions are clamped between elastic pieces wherein a front surface side of the panel is positioned (for example, see Paragraph [0021] and FIG. 6 of Patent Document 1).

### PRIOR ART DOCUMENT

### Patent Document

Patent Document 1: Japanese Patent Publication No. 4023685

### SUMMARY OF THE INVENTION

### Problems to be Solved by the Invention

However, in the conventional clip, at the triangularly-disposed three portions, the clamping piece is required to be contacted with the back surface of the panel, so that an end portion at a front in a sliding direction of the clamping piece is extended long. However, if the end portion of the front of the clamping piece is extended long, when the clamping piece slides, the clamping piece interferes with an edge of the attachment hole, so that there is a problem that the clamping piece might not smoothly slide into the attachment hole along the back surface of the panel.

For example, there is a case in which a component accuracy of the clamping piece is low so as to have warpage and the like in the end portion of the front of the clamping piece, or a case in which there is a “burr” in the edge of the attachment hole of the panel, or in which there is a distortion in the panel.

In those cases, the end portion of the front of the clamping piece and the edge of the attachment hole are interfered with, so that there is a case in which it is difficult to place the clamping piece by sliding, or in which it is difficult to remove the clamping piece by sliding in an opposite direction.

Hence, the present invention is made in view of the problem of the aforementioned conventional technology, and an object of the invention is to prevent the interference between the clamping piece and the attachment hole by configuring a distance from a front end portion of the clamping piece at the front in the sliding direction to an edge portion of the attachment hole positioned at front in the sliding direction, longer than a sliding amount, so that the clip can be smoothly and easily attached and removed.

### Device for Solving the Problems

The present invention is made in order to achieve the above-mentioned object, and has the following characteristics.

First, the clip comprises the following structure.

(1) Fixing Portion

A fixing portion is fixed to an attachment hole passing through front and back surfaces of a panel.

(2) Holding Portion

A holding portion is integrally provided in the fixing portion, protrudes from the front surface of the panel, and can hold a component (not shown in the figures).

Secondly, the fixing portion comprises the following structure.

(3) Elastic Piece

An elastic piece elastically abuts against the front surface of the panel.

(4) Support Pillar

A support pillar extends toward the attachment hole from the elastic piece.

(5) Clamping Piece

A clamping piece protrudes from an end portion of the support pillar, includes an external form capable of passing through the attachment hole, and for example, as shown in FIGS. 7 and 8, abuts against the back surface of the panel when the clamping piece slide in one direction after passing through the attachment hole.

(6) Operating Piece

An operating piece is provided in one portion of the elastic piece.

Thirdly, the clamping piece is configured so that a distance from a front end portion at a front in a sliding direction to an edge portion of the attachment hole positioned in front in the sliding direction is longer than a sliding amount.

The present invention may also comprise the following characteristic.

Specifically, the front end portion of the clamping piece is located on one surface where a front surface of the support pillar is located.

Thereby, by forming the front end portion of the clamping piece is located one surface where the front surface of the support pillar is located, rigidity of the clamping piece can be improved.

The present invention may comprise the following characteristic.

In the front end portion of the clamping piece, a guide inclined plane obliquely inclined toward a back in the sliding direction is formed.

Thereby, by forming the guide inclined plane obliquely inclined toward the back in the sliding direction in the front end portion of the clamping piece, interference with the attachment hole at an insertion time of the clamping piece can be reduced.

The present invention may comprise the following characteristic.

In the holding portion, a supporting piece extending toward the front surface of the panel and abutting against the front surface is formed.

Thereby, by forming the supporting piece abutting against the front surface of the panel in the holding portion, the component can be held without wobbling.

### Effect of the Invention

Since the present invention is structured as mentioned above, by configuring the distance from the front end portion of the clamping piece at the front in the sliding direction to the edge portion of the attachment hole positioned in front in the sliding direction longer than the sliding amount, the interference between the clamping piece and the attachment hole can be prevented, and the clip can be smoothly and easily attached and removed.

### BRIEF DESCRIPTION OF THE DRAWINGS

FIG. 1 is a side view of a clip in a state inserted in an attachment hole of a panel.

FIG. 2 is a side view of the clip.

FIG. 3 is a front view of the clip.

FIG. 4 corresponds to FIG. 2, and is a side view in a state wherein an arm portion is closed.

FIG. 5 is a plan view of the attachment hole of the panel.

FIG. 6 is a side view when the clip is attached to the panel.

FIG. 7 is a side view in a state wherein the clip is attached to the panel.

FIG. 8 is a cross-sectional view taken along a line A-A in FIG. 7.

### EMBODIMENT FOR CARRYING OUT THE INVENTION

(Clip 10)

In the drawings, the reference numeral 10 represents a clip, and through the clip 10, a component (not shown in the figures) is fastened to a panel 20.

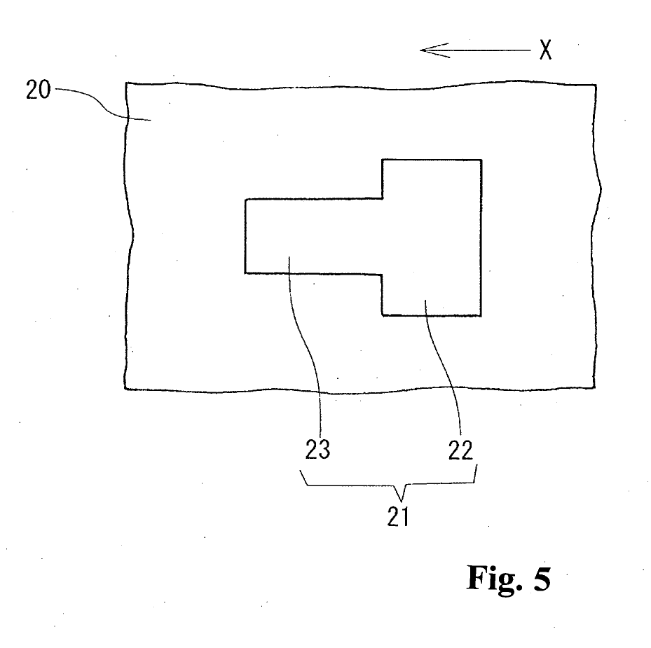

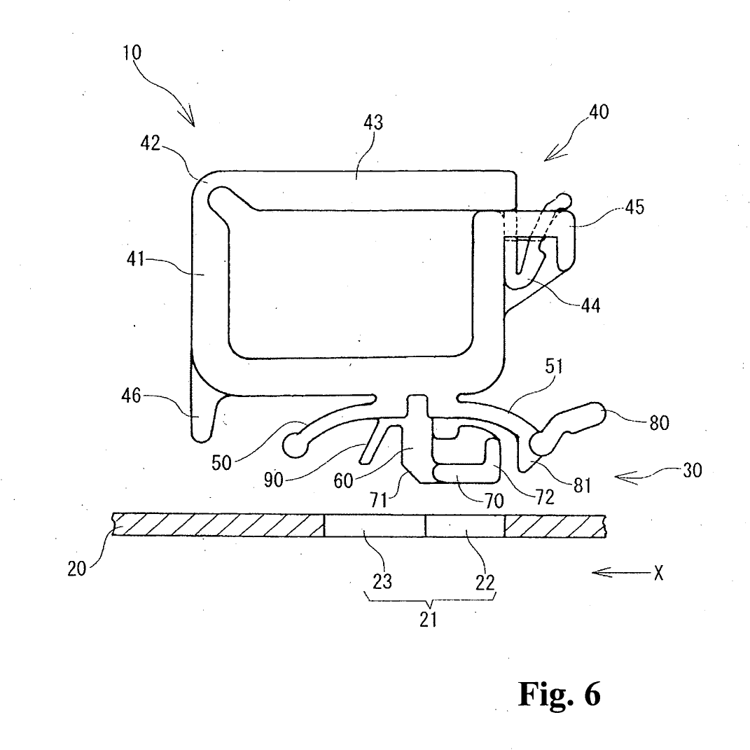

As shown in FIGS. 5 and 6, in the panel 20, an attachment hole 21 passing through front and back surfaces is formed. The attachment hole 21 is formed so as to have, for example, an approximately T-shaped planar face, and includes a wide portion 22, and a narrow portion 23 positioned in front in a sliding direction X of the wide portion 22 and continuing to the wide portion 22, whose width is narrower than that of the wide portion 22.

Incidentally, although an approximately T-shape is illustrated by an example as a shape of the attachment hole 21, the shape is not limited to the above provided that the shape is a combination of the wide portion 22 and the narrow portion 23.

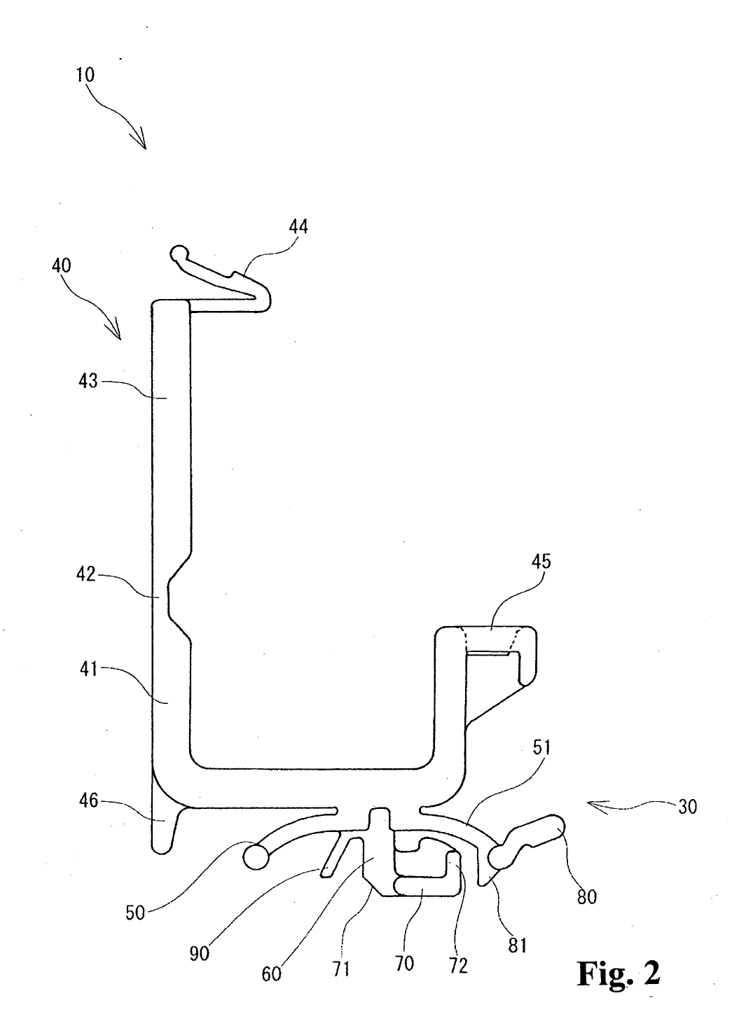

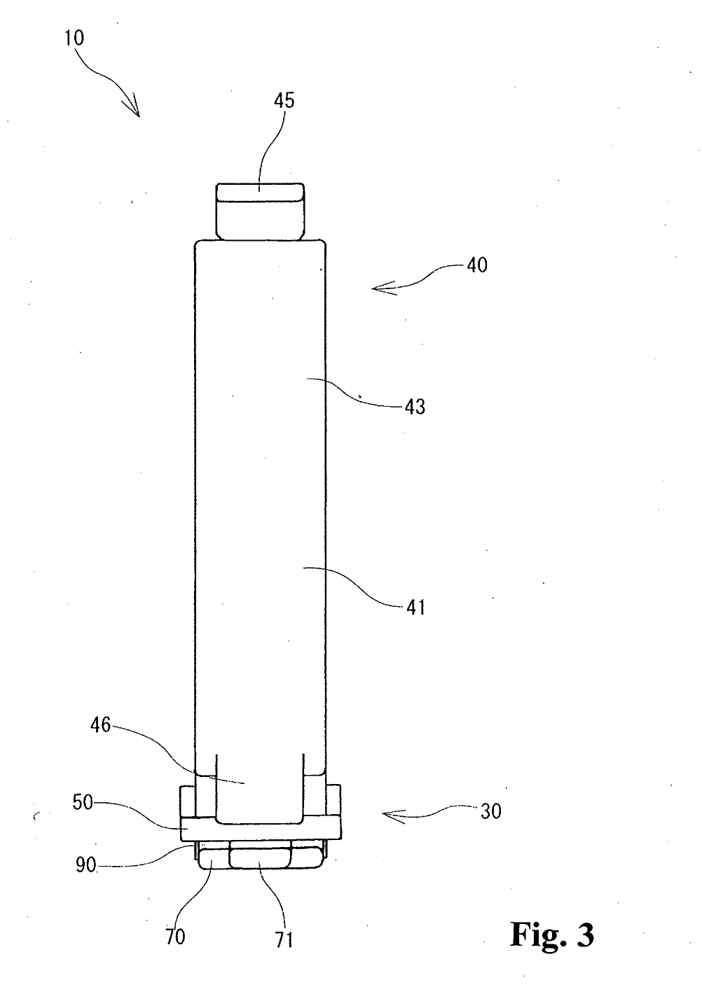

As shown in FIGS. 2 and 3, the clip 10 broadly comprises the following respective portions, and is integrally formed by thermoplastic resin including moderate elasticity and rigidity.

Incidentally, the following (1) and (2) will be described hereinafter.

(1) Fixing Portion 30

(2) Holding Portion 40

Incidentally, each portion of the clip 10 is not limited to the following (1) and (2).

(Fixing Portion 30)

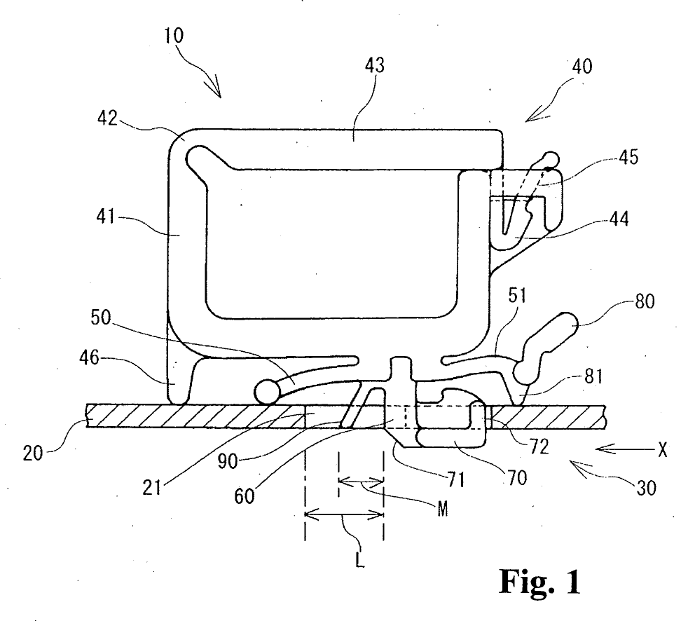

As shown in FIGS. 1 to 3, the fixing portion 30 is fixed to the attachment hole 21 passing through the front and back surfaces of the panel 20.

Specifically, as shown in FIGS. 2 and 3, the fixing portion 30 comprises the following respective portions.

Incidentally, the following (1) to (5) will be described hereinafter.

(1) Elastic Pieces 50, 51

(2) Support Pillar 60

(3) Clamping Piece 70

(4) Operating Piece 80

(5) Abutting Piece 90

Incidentally, each portion of the fixing portion 30 is not limited to the following (1) to (5).

(Holding Portion 40)

As shown in FIGS. 1 to 3, the holding portion 40 is integrally provided in the fixing portion 30, protrudes from the front surface of the panel 20, and can hold the component (not shown in the figures).

Specifically, as shown in FIGS. 2 and 3, the holding portion 40 comprises the following respective portions.

(1) Main Body Portion 41

As shown in FIG. 2, a main body portion 41 is formed in a frame form whose top face is open so as to be capable of receiving the component from the open top face.

(2) Hinge Portion 42

As shown in FIG. 2, a hinge portion 42 is formed so as to be thin-walled, and is for connecting one end portion of the main body portion 41 and an arm portion 43 described hereinafter.

(3) Arm Portion 43

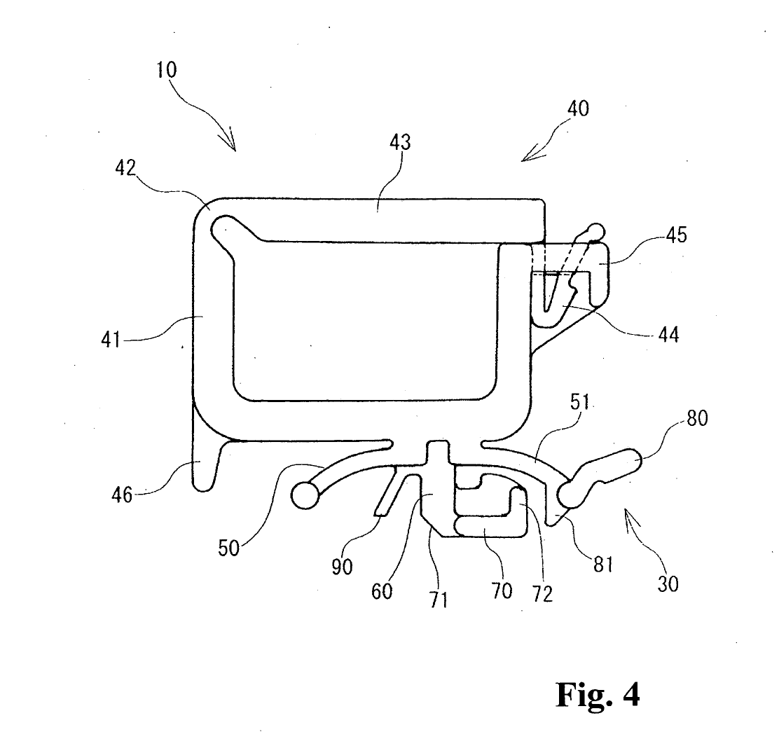

As shown in FIGS. 2 and 4, the arm portion 43 is connected to an upper portion of one end portion of the main body portion 41 through the hinge portion 42, and is for opening and closing the open top face of the main body portion 41.

(4) Lock Piece 44

A shown in FIGS. 2 and 4, a lock piece 44 is formed in a free end portion of the arm portion 43, and is for locking the arm portion 43 relative to the main body portion 41 in a state wherein the open top face of the main body portion 41 is closed.

Specifically, the lock piece 44 is folded in an approximately V-shape from the free end portion of the arm portion 43.

(5) Lock Portion 45

As shown in FIGS. 2 and 4, a lock portion 45 engages the lock piece 44, and is for locking the arm portion 43 in a closed state.

Specifically, the lock portion 45 is formed in an upper portion of the other end portion of the main body portion 41, and formed in a hole shape wherein the approximately V-shaped lock piece 44 is fitted in.

The lock piece 44 is locked in a state fitted in the hole-shaped lock portion 45, and by bending the lock piece 44 in an approaching direction, a lock state can be released.

(6) Supporting Piece 46

As shown in FIGS. 1 to 3, a supporting piece 46 extends downward from a lower portion of one end portion including the hinge portion 42 of the main body portion 41 toward the front surface of the panel 20. Also, an end portion of the supporting piece 46 abuts against the front surface of the panel 20.

The supporting piece 46 is positioned directly beneath the hinge portion 42, so that when the arm portion 43 is opened and closed through the hinge portion 42, the supporting piece 46 can prevent the main body portion 41 from bending downward.

(Elastic Pieces 50, 51)

As shown in FIGS. 1 to 3, the elastic pieces 50, 51 elastically abut against the front surface of the panel 20.

Specifically, as shown in FIGS. 1 to 3, a pair of the elastic pieces 50, 51 is curved downward in an arc shape and extends from a front surface and a back surface of the support pillar 60 described hereinafter and positioned in a front and a back in the sliding direction X. The elastic pieces 50, 51 are positioned away from a lower surface of the main body portion 41 of the aforementioned holding portion 40.

Incidentally, although a pair of the elastic pieces 50, 51 is formed, the elastic pieces 50, 51 are not limited to the pair, and may be provided as one or three or above.

(Support Pillar 60)

As shown in FIGS. 1 and 2, the support pillar 60 extends toward the attachment hole 21 from the elastic pieces 50, 51.

Specifically, as shown in FIGS. 1 and 2, the support pillar 60 is connected to the lower surface of the main body portion 41 of the aforementioned holding portion 40, and has a height more than a board thickness of the panel 20.

(Clamping Piece 70)

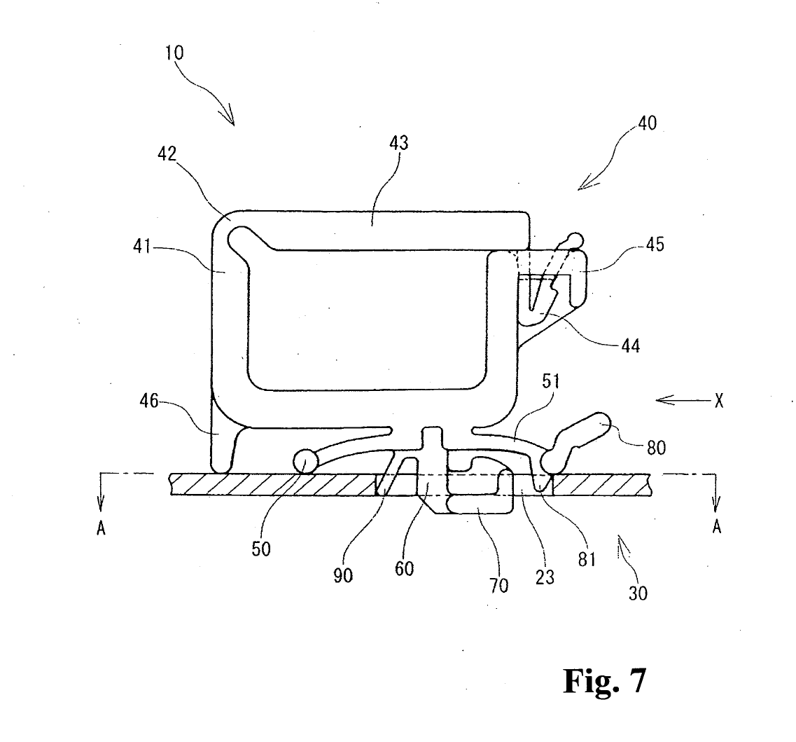

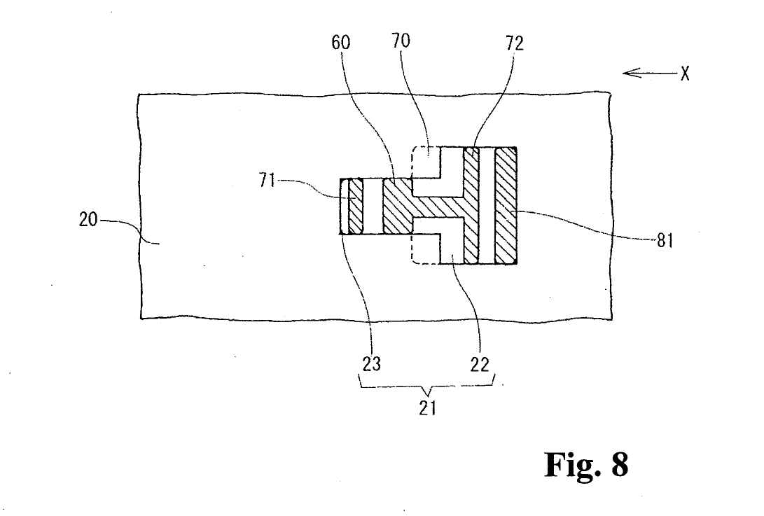

As shown in FIGS. 1 to 3, the clamping piece 70 protrudes from an end portion of the support pillar 60, includes an external form capable of passing through the attachment hole 21, and as shown in FIGS. 7 and 8, abuts against the back surface of the panel 20 when the clamping piece 70 is slid in one direction after passing through the attachment hole 21.

Specifically, the clamping piece 70 respectively protrudes from right-and-left side surfaces of the support pillar 60 perpendicular to the sliding direction X. A right-and-left width of the clamping piece 70 is configured so as to have a width less than the wide portion 22 of the attachment hole 21, and also to have a width more than the narrow portion 23.

Consequently, the clamping piece 70 can be inserted into a back surface side of the panel 20 through the wide portion 22 of the attachment hole 21. After that, when the clamping piece 70 slides in the sliding direction X, the clamping piece 70 moves to the narrow portion 23, and at this time, both right-and-left end portions of the clamping piece 70 are positioned in the back surface of the panel 20 so as to clamp the panel 20 between the elastic pieces 50, 51 from the front and back surfaces.

On the other hand, as shown in FIG. 1, the clamping piece 70 is configured so that a distance L from a front end portion in a front in the sliding direction X to an edge portion of the attachment hole 21 positioned in front in the sliding direction X is longer than a sliding amount M.

Specifically, as shown in FIGS. 1 and 2, a front end portion of the clamping piece 70 is located on a plane where the front surface of the support pillar 60 is located.

Also, as shown in FIGS. 1 and 2, in the front end portion of the clamping piece 70, a guide inclined plane 71 obliquely inclined toward the back in the sliding direction X is formed.

Moreover, as shown in FIGS. 1 and 2, in the clamping piece 70, a control piece 72 bent upward in an L shape in a cross-sectional surface is formed in the back end portion of the back in the sliding direction X.

As shown in FIG. 1, the control piece 72 abuts against a back edge portion in the back in the sliding direction X of the attachment hole 21 so as to control a backward movement position of the clamping piece 70 inside the attachment hole 21.

(Operating Piece 80)

As shown in FIG. 2, the operating piece 80 is provided in one portion of the elastic pieces 50, 51.

Specifically, the operating piece 80 extends obliquely upward toward the back in the sliding direction X from the elastic piece 51 positioned in the back in the sliding direction X, among the elastic pieces 50, 51 positioned in the front and the back. In a lower end portion of the operating piece 80, a locking claw 81 extending downward in a claw shape is formed.

As shown in FIG. 1, the locking claw 81 abuts against the front surface of the panel 20 in a state wherein the clamping piece 70 is inserted into the attachment hole 21 of the panel 20. After that, when the clamping piece 70 slides, as shown in FIG. 7, the locking claw 81 is fitted in the attachment hole 21 of the panel 20, and at this time, the locking claw 81 abuts against the back edge portion at the back in the sliding direction X of the attachment hole 21.

(Abutting Piece 90)

As shown in FIG. 7, the abutting piece 90 elastically abuts against an inner edge of the attachment hole 21 of the panel 20.

Specifically, as shown in FIG. 2, the abutting piece 90 extends obliquely downward from a base end portion of the support pillar 60 toward the front in the sliding direction X.

As shown in FIG. 7, the abutting piece 90 elastically abuts against a front edge portion at the front in the sliding direction X of the attachment hole 21 when the clamping piece 70 slides after the clamping piece 70 is inserted into the attachment hole 21 of the panel 20. Consequently, due to a reaction force of the abutting piece 90, the locking claw 81 of the aforementioned operating piece 80 also elastically abuts against the back edge portion of the attachment hole 21.

(Mounting Method of Clip 10)

A method mounting the clip 10 comprising the aforementioned structure on the attachment hole 21 of the panel 20 will be explained.

First, as shown in FIG. 6, the clamping piece 70 of the clip 10 is positioned on an upper side of the wide portion 22 of the attachment hole 21.

Next, as shown in FIG. 1, the clamping piece 70 of the clip 10 is inserted by matching with the wide portion 22 of the attachment hole 21.

After that, with the holding portion 40 projecting on a front surface side of the panel 20 and the like, the clip 10 is slid in the sliding direction X.

As shown in FIG. 8, when the clip 10 is slid, the clamping piece 70 moves to the narrow portion 23 from the wide portion 22 of the attachment hole 21, and both the right-and-left end portions of the clamping piece 70 are positioned in the back surface of the panel 20 so as to clamp the panel 20 between the elastic pieces 50, 51 from the front and back surfaces.

At this time, the locking claw 81 of the operating piece 80 falls in an inside of the attachment hole 21, and abuts against the back edge portion of the attachment hole 21. At the same time, the abutting piece 90 elastically abuts against the front edge portion of the attachment hole 21. Due to the reaction force of the abutting piece 90, the locking claw 81 elastically abuts against the back edge portion of the attachment hole 21, so that the clamping piece 70 is locked inside the attachment hole 21 so as not to be capable of sliding.

(Dismounting Method of Clip 10)

Next, a dismounting method of the clip 10 will be explained.

The operating piece 80 is pushed in a direction separating from the front surface of the panel 20, i.e., upward. When the operating piece 80 is pushed up, due to the reaction force of the abutting piece 90, the locking claw 81 emerges from the attachment hole 21 in such a way as to move to the back in the sliding direction X. Thereby, the lock state is released so as to allow the clamping piece 70 to slide.

After that, by sliding the clamping piece 70 toward the back in the sliding direction X, positioning the clamping piece 70 in the wide portion 22 of the attachment hole 21, and removing the clamping piece 70 by passing the clamping piece 70 through the wide portion 22, the clip 10 can be removed from the panel 20. The specification, claims, drawings, and abstract of Japanese Patent Application No. 2009-106086 filed on Apr. 24, 2009 are cited in their entirety herein and are incorporated as a disclosure of the specification of the present invention.

1. A clip, comprising:
a fixing portion fixed in an attachment hole passing through front and back surfaces of a panel; and
a holding portion integrally provided in the fixing portion, protruding from the front surface of the panel, and being capable of holding a component,
wherein the fixing portion comprises:
an elastic piece elastically abutting against the front surface of the panel;
a support pillar extending toward the attachment hole from the elastic piece;
a clamping piece protruding from an end portion of the support pillar, including an external form so as to be capable of passing through the attachment hole, and abutting against the back surface of the panel when the clamping piece slides in one direction after passing through the attachment hole; and
an operating piece provided at one portion of the elastic piece, and
wherein the clamping piece is configured so that a distance from a front end portion in a front in the sliding direction to an edge portion of the attachment hole positioned in front of the sliding direction is longer than a sliding amount.

2. A clip according to claim 1, wherein the front end portion of the clamping piece is formed in a plane where a front surface of the support pillar is located.

3. A clip according to claim 1, wherein the front end portion of the clamping piece forms a guide inclined plane obliquely inclined toward a back in the sliding direction.

4. A clip according to claim 1, wherein the holding portion forms a supporting piece extending toward the front surface of the panel and abutting against the front surface.
